(19) United States
(12) Patent Application Publication
(10) Pub. No.: US 2010/0301137 A1
(43) Pub. Date: Dec. 2, 2010

(54) CONDUIT REEL FOR DRIPPER IRRIGATION LINE

(76) Inventor: Sharona KEREN, Karjur (IL)

Correspondence Address: YORAM TSIVION, P.O. BOX 1307, PARDES HANNA, 37111, IL

(21) Appl. No.: 12/744,682

(22) PCT Filed: Jul. 22, 2008
(86) PCT No.: PCT/IL08/01012

§ 371 Date: May 26, 2010

Related U.S. Application Data
(60) Provisional application No. 60/952,599, filed on Jul. 30, 2007.

(51) Int. Cl. B65H 75/44; B65H 75/30; B05B 17/00

(52) U.S. Cl. 239/289; 242/398; 242/395; 242/388.6

(57) ABSTRACT

A reel device for winding/unwinding a continuous dripper irrigation line thereby customizably deploying the dripper irrigation line over an irrigated area and providing irrigation to the area is disclosed. The device includes: a structural frame-work, a rotational pivot suspended by the structural framework, at least one reel sub-unit revolving around the pivot, and a swivel conduit connector having at least one outlet, whereto the dripper irrigation line is connected. The reel device as well as irrigation systems in which such devices can be implemented are equivalently applicable for gardening, farming, industrial agriculture cultivation and crop growing, and for growth of any vegetation type or plant for any purpose whatsoever that reacquire an irrigation.

### FIELD OF THE INVENTION

The present invention relates to irrigation devices in general and more particularly, to a reel device for winding on an irrigation pipe.

### BACKGROUND OF THE INVENTION

Irrigation is an artificial application of water to the soil and is widely used at fields, gardens or elsewhere. Since firstly employed by the mankind, as far back as the 6th millennium BCE in Mesopotamia and Egypt, many different techniques and elaborations were explored. Among the challenges of the irrigation remain: delivering the water effectively to the roots of the plants or to the roots' area as well as reducing water waste caused by evaporation and winds. Therefore, drip irrigation, also known as trickle irrigation or micro-irrigation, is one of the leading trends at the irrigation technologies. Effectively addressing both of the aforementioned challenges, drip irrigation has one significant drawback; it requires prior deployment of dripper irrigation line—irrigation tubing with emitters or drippers installed. The present invention presents a device that strives to simplify the task of dripper irrigation line deployment, provides for more customizable coverage of an irrigated area, and facilitates reversible installation, uninstallation and storage of the dripper irrigation line.

### SUMMARY OF THE INVENTION

There are provided in accordance with embodiments of the present invention a reel device for winding on an irrigation pipe, a method of using the same, and a system in which the reel device is implemented.

The device, in accordance with the present invention, includes: a structural framework, a rotational pivot, one or more reel sub-units coaxially revolving around the rotational pivot and preferably co-rotational, and a swivel conduit connector. The system in accordance with the present invention further includes an inlet and a dripper irrigation line.

### BRIEF DESCRIPTION OF THE DRAWINGS

The present invention will be understood and appreciated more fully from the following detailed description taken in conjunction with the appended drawings, in which:

FIG. 1 is an isometric view of the double-reel device of the present invention;

FIG. 2 is an isometric view of the single-reel device of the present invention;

FIG. 3 is an isometric view of an assembly of a double-reel device of the present invention and a rotating handle;

FIG. 4 is an illustrative diagram of some structural details of a double-reel device and the system in which the double-reel device is implemented;

FIG. 5 is a top view diagram illustrating possible deployment configuration of the systems of the present invention;

FIG. 6 is a top view diagram of some preferred embodiment of the system of the present invention.

While the invention is susceptible to various modifications and alternative forms, specific embodiments thereof have been shown by way of example in the drawings. The components in the drawings are not necessarily to scale, emphasis instead being placed upon clearly illustrating the principles of the present invention. It should be understood, however, that the description herein of specific embodiments is not intended to limit the invention to the particular forms disclosed, but on the contrary, the intention is to cover all modifications, equivalents, and alternatives falling within the spirit and scope of the invention.

### DISCLOSURE OF THE INVENTION

Illustrative embodiments of the invention are described below. In the interest of clarity, not all features of an actual implementation are described in this specification. It will of course be appreciated that in the development of any such actual embodiment, numerous implementation-specific ecisions must be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

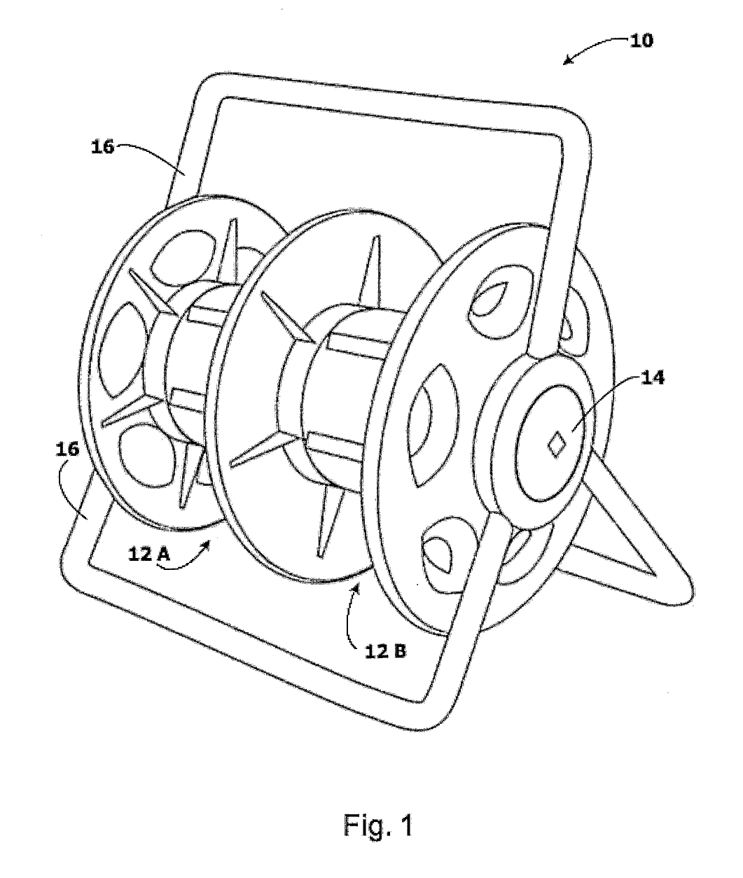

Reference is now made to FIG. 1, showing a schematic description of an exemplary double-reel device 10 of the present invention. First reel sub-unit 12A revolving coaxially with second reel sub-unit 12B around common pivot 14 so that their rotational movement is coupled.

Structural framework 16 on which rotational pivot 14 is mounted, keeps the reels at a certain distance from the ground.

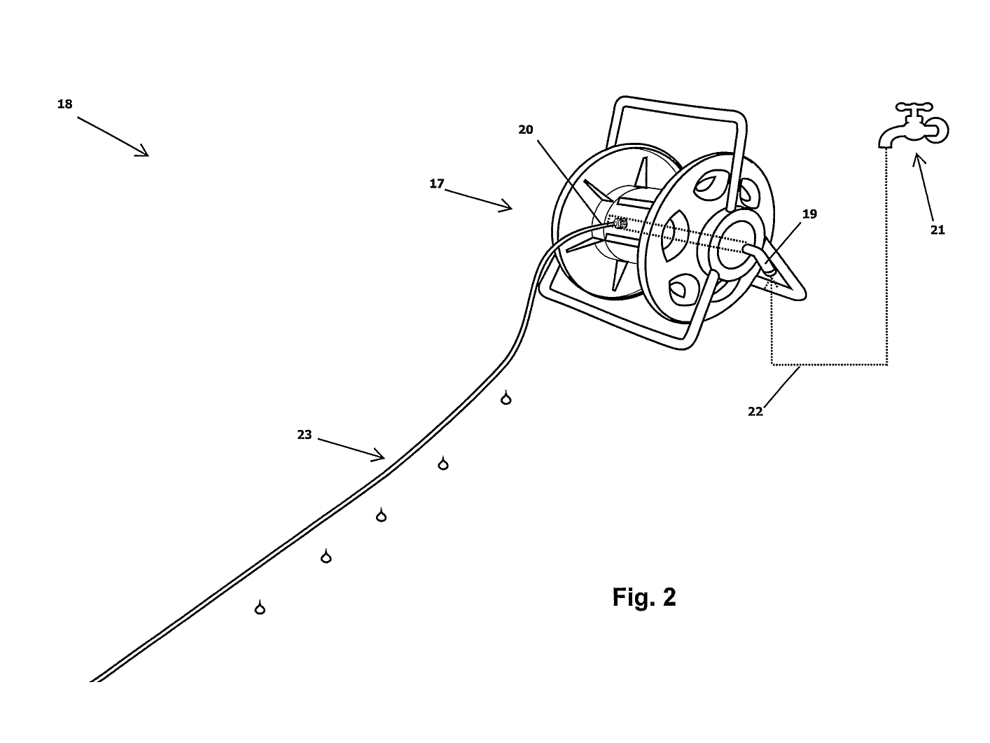

Reference is now made to FIG. 2, showing some structural details of an exemplary single-reel device 17, and illustrating system 18 in which single-reel device 17 is implemented. Swivel conduit connector 19, typically disposed coaxially with the pivot, wherefrom incoming feed of water is directed to outlet 20, sustains rotation of the reel. Swivel conduit connector 19, which is the inlet of single-reel device 17, is connected to inlet 21 of irrigation system 18 by means of a pipe, typically a garden hose, indicated by dashed line 22, and may be optionally furnished with a tap. One terminal end of dripper irrigation line 23 is connected to outlet 20, whereas the other terminal end can be blocked or furnished with a sprinkler.

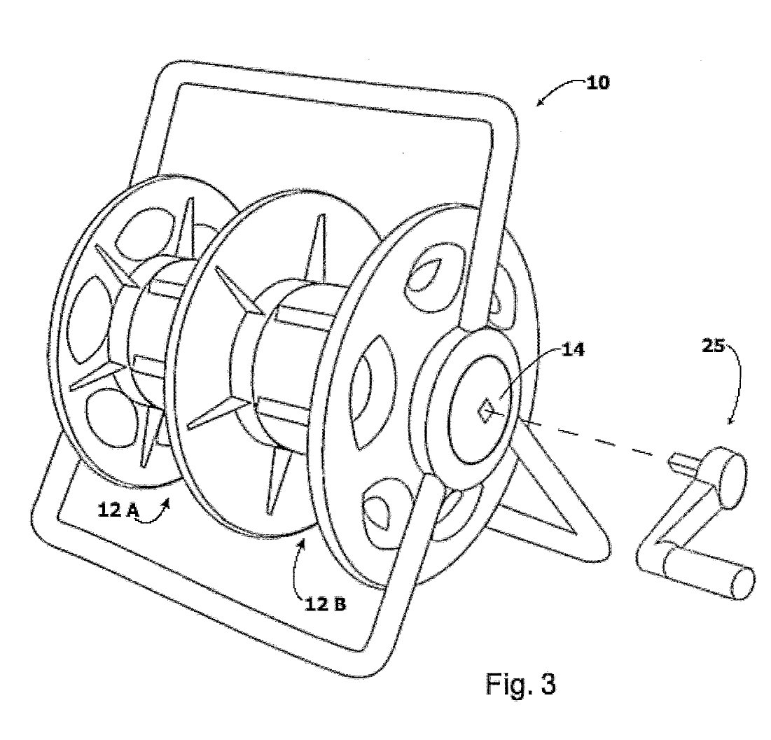

Reference is now made to FIG. 3, showing schematically a device in accordance with present invention, in which the exemplary double-reel device 10, illustrated in FIG. 1, is further furnished with a rotating handle 25 usable for applying rotational torque to pivot 14 in order to rotate reel sub-units 12A and 12B for winding or unwinding an irrigation pipe. The rotating handle is either fixed to the pivot or removabaly attached to it.

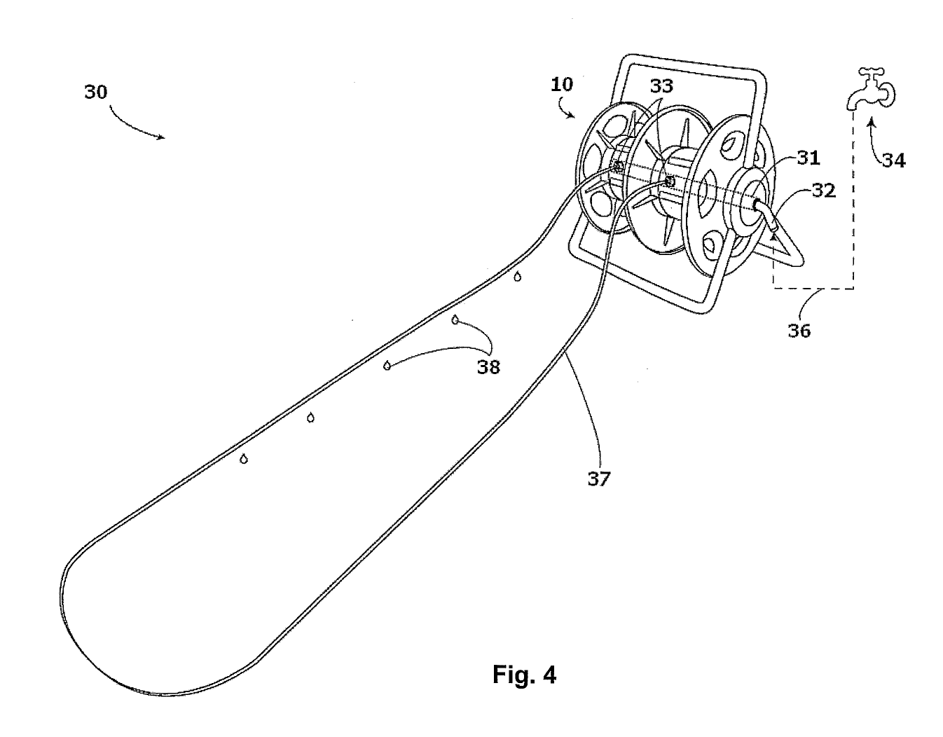

Reference is now made to FIG. 4, showing some structural details of the exemplary double-reel device 10, illustrated in FIG. 1, and illustrating system 30 in which double-reel device 10 is implemented.

Disposed coaxially with the pivot is manifold 31 which distributes the stream of water incoming from inlet 32 to a plurality of outlets 33. Swivel conduit connector 32, which is the inlet of double-reel device 10, is connected to inlet 34 of irrigation system 30 by means of a pipe, typically a garden hose, indicated by dashed line 36, and may be optionally furnished with a tap.

Terminal ends of continuous dripper irrigation line 37 are connected to outlets 33. Dripper irrigation line 37 is furnished with a plurality of dripper nozzles (not shown) or alternatively simply pierced, providing for applying the water to the roots of plants, by dripping water droplets 38 onto the soil surface or directly to the root zone.

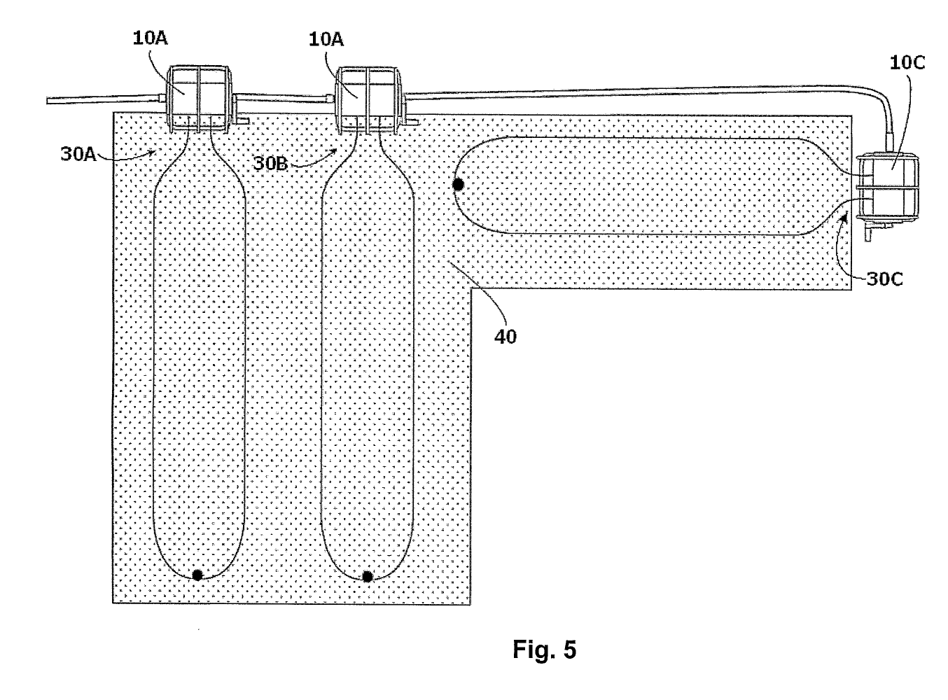

Reference is now made to FIG. 5, illustrating a possible deployment layout scheme of irrigation systems 30 A-C, in which double-reel devices 10 A-C are respectfully implemented, provide irrigation effectively covering non-rectangular area 40.

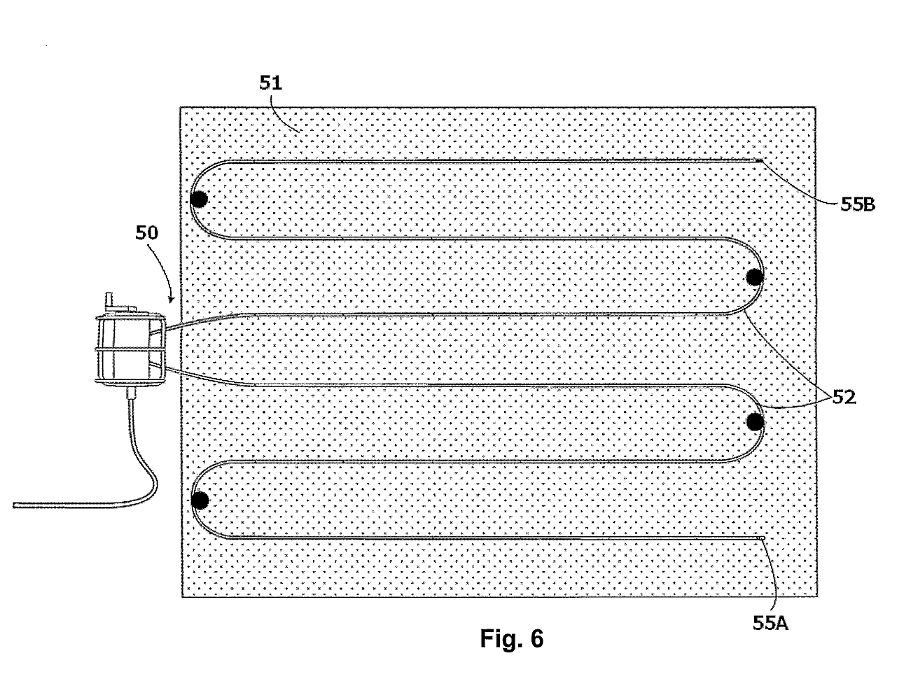

Reference is now made to FIG. 6, in which according to some preferred embodiments of the present invention system 50 is used to provide irrigation effectively covering rectangular area 51. System 50 is characterized by dripper irrigation line 52 furnished with plug connector which includes plug connector sub-unit 55 A and respective plug connector sub-unit 55 B. Plug connector sub-unit 55 A can be plugged into plug connector sub-unit 55 B connecting dripper irrigation line 52 thus creating continuum of the entire lumen of dripper irrigation line 52. Connector sub-units 55 A and B can be severed splitting dripper irrigation line 52; what provides for more versatile coverage of an irrigated area.

In light of the above, it should be stressed that the device where shown as a double-reel is for demonstration proposal only, and a single-reel and/or multi-reel devices are equivalently applicable.

The dripper irrigation line can be one of the lines known in the art and manufactured in industry, inter alia any kind of a drip irrigation line furnished with plurality of dripper nozzles or sprinklers, in which water is emitted at spaced points, or a porous drip irrigation tubing that allows water to seep out along the entire length of the tube, such as the “Conduit 100′ Drip Tubing [Catalogue Number (SHD+C-100)]” available form Irrigro USA-LPO Box 163, 175 Reference is now made to FIG. 4, showing some structural details of the exemplary double-reel device 10, illustrated in FIG. 1, and illustrating system 30 in 5 Factory Outlet Blvd, Niagara Falls, NY-USA 14304-0163.

It should be acknowledged the double-reel device illustrated in FIG. 1 as well as a single-reel and/or multi-reel devices in accordance with the present invention and irrigation systems in which such devices implemented are equivalently applicable for gardening, farming, industrial agriculture cultivation and crop growing, and for growth of any vegetation type or plant for any purpose whatsoever that reacquire an irrigation.

It will be appreciated by persons skilled in the art that the present invention is not limited by what has been particularly shown and described herein above and that numerous modifications, all of which fall within the scope of the present invention, exist. Rather the scope of the invention is defined by the claims which follow:

1. A reel device for winding/unwinding a continuous dripper irrigation line whereby customizably deploying said dripper irrigation line over an irrigated area and providing irrigation to said area, said device comprising:
a structural framework;
a rotational pivot suspended by said structural framework;
at least one reel sub-unit revolving around said pivot, and
a swivel conduit connector having at least one outlet, whereto said dripper irrigation line is to be connected.

2. The reel device as in claim 1, further comprising at least one dripper irrigation line, having two terminal ends, wherein at least one of said ends connected to said at least one outlet.

3. The reel device as in claim 1, wherein said at least one reel sub-unit is a single one reel sub-unit.

4. The reel device as in claim 1, wherein said at least one reel sub-unit is any natural number of reel sub-units greater than one and lesser than 100, wherein said swivel conduit connector further comprising a manifold having at least two outlets.

5. The reel device as in claim 1, further comprising a rotating handle to apply a rotational torque to said pivot; whereby said at least one reel sub-unit is being rotated; and whereby a dripper irrigation line is being winded onto and around said reel sub-unit.

6. The reel device as in claim 5, wherein said rotating handle is removably attached to said pivot.

7. The reel device as in claim 5, wherein said rotating handle is firmly fixed to said pivot.

8. A system for deploying dripper irrigation line comprising:
an inlet feeding water into the system;
a reel device for winding/unwinding a continuous dripper irrigation line comprising:
a) a structural framework;
b) a rotational pivot suspended by said structural framework;
c) a swivel conduit connector having at least one outlet; and
d) at least one reel sub-unit revolving around said pivot;
at least one dripper irrigation line having two terminal ends, wherein at least one of said ends is connected to said at least one outlet.
